(19) United States
(12) Patent Application Publication
(10) Pub. No.: US 2010/0140159 A1
(43) Pub. Date: Jun. 10, 2010

(54) DRAINAGE ELEMENT

(76) Inventor: Thomas Vaeth, Gross-Zimmern (DE)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/440,583

(22) PCT Filed: Sep. 1, 2007
(86) PCT No.: PCT/DE2007/001573

§ 371 Date: Jan. 5, 2010

(30) Foreign Application Priority Data
Sep. 16, 2006 (DE) 10 2006 043 571.0

(51) Int. Cl. B01D 35/02; B01D 35/28

(52) U.S. Cl. 210/248

(57) ABSTRACT

The present invention is a drainage element for a plant container including in a preferred embodiment a first element having randomly oriented interlacing and a second element including a filter mat which encases the randomly oriented interlacing. In another preferred embodiment, the filter mat element overlies the randomly oriented interlacing when in use, for example to cover the bottom of a plant container.

### BACKGROUND OF THE INVENTION

The invention relates to a drainage element for a plant container.

### SUMMARY OF THE INVENTION

Known from EP 1 702 506 A1 is a drainage element, therein called Drainage Set for plant containers, which presents a cohesive covering made of geotextile tissue. Contained within is a drainage material in the form of grains. Due to gravity such a grain is squeezable into a drainage hold of a plant container and the drainage hold thus sealable. The enclosing geotextile tissue serves as a seal in this environment. Drainage is not provided for.

Known from DE 203 12 056 is a drainage element, therein called drainage element, which consists of a covering with a hole to enable fluids to pass through and a drainage mass, wherein the drainage mass is encased by the covering and consists of at least two different water-storing and respectively water-conducting components.

Collectively termed geotextiles are functional textiles used in civil and underground engineering to separate, filter and drain. One of these geotextiles is an endless mat, also known as a geogrid, which presents a randomly oriented interlacing in between two filter materials.

The endless mats are open on the side margins and the specific strata are recognizable. At least one of the filter mats overlaps in such a way that the filter mats of adjoined geotextile mats prevent openings overlapping each other and thus the leakage of sand and such like is averted.

The invention therefore underlies the task of providing for an easier and improved drainage element.

This task is achieved through the criteria of the coordinate main claims. In accordance with the invention, the drainage element presents a randomly oriented interlacing and a filter mat which encases the randomly oriented interlacing or the drainage element presents a randomly oriented interlacing and a filter mat, wherein the filter mat overlaps in such a way that in the operating state the randomly oriented interlacing is covered by the filter mat. The randomly oriented interlacing is of such stiffness that it is capable of keeping its original height even under the pressure of incumbent flower soil and thus will not be compressed under such circumstances. The drainage element is manufactured with a low height or thickness and provides for optimal drainage. Accordingly, siltation and rot in a plant container is precluded. Plant containers are subsequently also referred to as flower containers or flower pots and the drainage element is also referred to as drainage cushion, drainage pad or, in short, a drainpad. The filter mat serves as filter layer and is thus referred to as filter layer. The drainage element prevents flower soil and substrate from flushing out, so that a loss of substrate and flower soil as well as pollution around the plant container is averted. The substrate serves as a breeding ground. The drainage element is extremely light in weight, easy to clean and reusable.

At least one end area of the filter mat is sewn together. A first embodiment presents a one-piece filter mat. One end area is sewn so that the filter mat encases the randomly oriented interlacing. In a second embodiment, the drainage element presents a two-piece filter mat and the end areas are sewn together. The drainage element is designed as a pad and thus easy to produce.

At least one end area of the filter is welded together. A first embodiment presents a one-piece filter mat. One end area is welded so that the filter mat encases the randomly oriented interlacing. In a second embodiment, the drainage element presents a two-piece filter mat and the end areas are welded together. The drainage element is designed as a pad and thus easy to produce.

At least one end area of the filter mat is glued together. A first embodiment presents a one-piece filter mat. One end area is glued so that the filter mat encases the randomly oriented interlacing. In a second embodiment, the drainage element presents a two-piece filter mat and the end areas are glued together. The drainage element is designed as a pad and thus easy to produce.

For a better understanding of the invention, the embodiments are subsequently elucidated in more detail on the basis of the drawings.

### BRIEF DESCRIPTION OF THE FIGURES

FIG. 1A a plan view of a disc-shaped drainage element with a randomly oriented interlacing and two-piece filter mat covering the randomly oriented interlacing.

FIG. 1B is a cross-sectional view of the drainage element of FIG. 1A with the randomly oriented interlacing encased by the filter mat.

FIG. 2A a plan view of a rectangular-shaped drainage element with a randomly oriented interlacing and a one-piece filter mat covering the randomly oriented interlacing.

FIG. 2B is a cross-sectional view of the drainage element of FIG. 1B with the randomly oriented interlacing encased by the filter mat.

FIG. 3A a plan view of an alternative embodiment of a rectangular-shaped drainage element with a randomly oriented interlacing and a filter mat attached to one side of the randomly oriented interlacing.

FIG. 3B is a side elevational view of the drainage element of FIG. 3A with a randomly oriented interlacing and a filter mat attached to one side of the randomly oriented interlacing from side view.

FIG. 4 is a cross-sectional view of the drainage element of FIGS. 1A and 1B shown in place in a conical flower container.

FIG. 5 is a cross-sectional view of the drainage element of FIGS. 3A and 3B shown in place in a rectangular flower container.

### DESCRIPTION OF THE INVENTION

Elements that are similar or the same are marked with identical reference signs throughout the various figures.

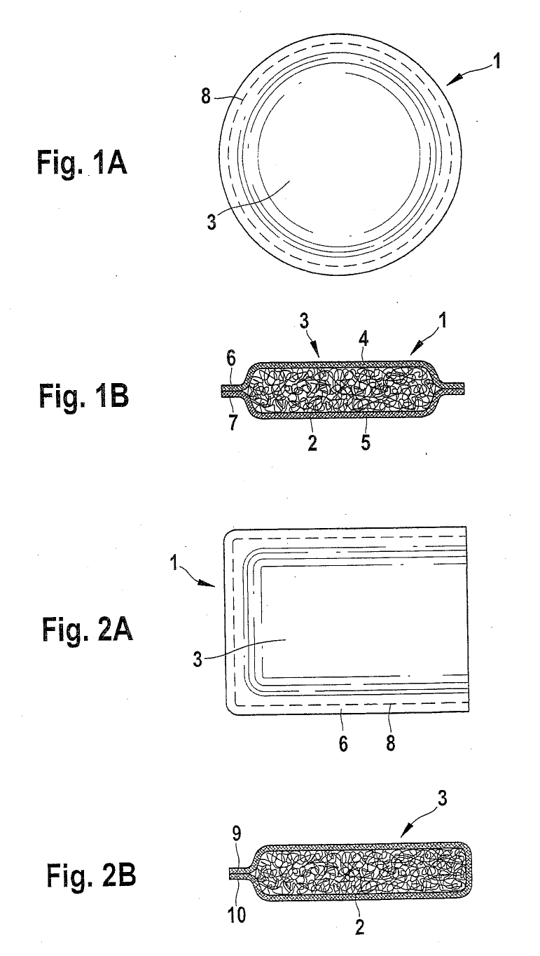

FIGS. 1A and 1B depict a disc-shaped drainage element 1 with a randomly oriented interlacing 2, encased by a two-piece filter mat 3. The randomly oriented interlacing 2 is also disc-shaped and presents two round frontal areas and a peripheral surface. The filter mat 3 consists of two parts carried out with two filter mat pieces 4 and 5. The first filter mat piece 4 covers the first frontal area and shows an end area 6 that protrudes beyond the frontal area. The second filter mat piece 5 covers the second frontal area and shows an end area 7 that protrudes beyond the second frontal area. The outer end areas 6 and 7 which overlap on the peripheral surface are sewn together with thread 8. The end areas 6 and 7 could alternatively be glued or welded together as well.

FIGS. 2A and 2B depict a rectangular-shaped drainage element 1 with a rectangular-shaped randomly oriented interlacing 2, encased by a one-piece filter mat 3. The randomly oriented interlacing 2 presents an upper surface and an opposing bottom surface and four peripheral sides with smaller surfaces. The filter mat 3 is put around the randomly oriented interlacing 2 in such a way so as to enclose the interlacing 2. The filter mat 3 presents an outer end area 6 that protrudes above three sides and is sewn. Components 9 and 10 of the end area 6 come to lie on top of each other at three peripheral sides and are there sewn together.

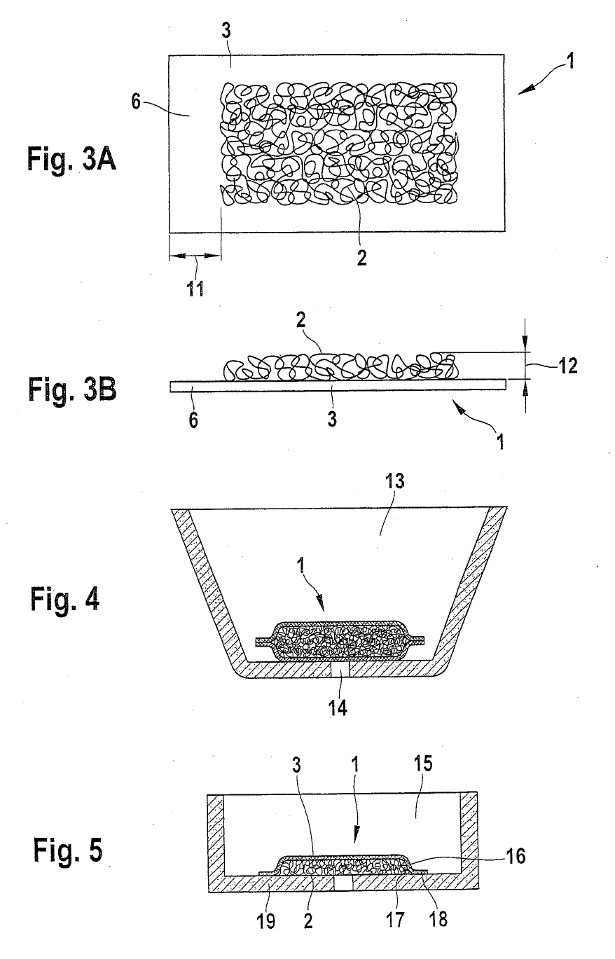

FIGS. 3A and 3B depict a second rectangular drainage element 1 with a rectangular randomly oriented interlacing 2 and a filter mat 3. The filter mat 2 covers one side of the randomly oriented interlacing 2 and presents an overlapping end area that protrudes above the randomly oriented interlacing 3. One length 11 of the end area 6 is chosen in such a magnitude that a value of this length is greater than a value of a height 12 of the randomly oriented interlacing 2.

FIG. 4 depicts the disc-shaped drainage element 1 arranged in a round plant container 13. A flower pot outlet 14 of the flower pot 13 is covered by using the drainage element 1. So if the flowerpot 13 is filled up with flower soil, substrate and a plant, the drainage element 1 will keep its original height and when watering the flower pot 13 the water will be able to drain off the drainage element 1 and out the flower pot outlet 14.

FIG. 5 depicts the second rectangular drainage element 1 arranged in an oblong square flower pot 15. The filter mat 3 is chosen in such a magnitude that it fits a side rim 17 of the randomly orientated interlacing at a first area 16 and comes to rest on a base 19 of the flower pot at a second area 18 in the operating state.

The invention relates to a drainage element 1 for a plant container 13. In accordance with the invention, the drainage element 1 presents a randomly oriented interlacing 2 and a filter mat 3 which surrounds the randomly oriented interlacing 2 or the drainage element 1 presents a randomly oriented interlacing 2 and a filter mat 3 and the filter mat 3 projects beyond the randomly orientated interlacing 2 in such a way that the randomly orientated interlacing 2 is covered by the filter mat 34 in the operating state.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A drainage element for a plant container, comprising a randomly oriented interlacing and a filter mat which encases the randomly oriented interlacing.

2. A drainage element according to claim 1, wherein the filter mat presents at least one end area being sewn.

3. A drainage element according to claim 1, wherein the filter mat presents at least one end area being welded.

4. A drainage element according to claim 1, wherein the filter mat presents at least one end area being glued.

5. A drainage element 1 for a plant container, comprising an element having a randomly oriented interlacing and a filter mat which covers the randomly oriented interlacing in the operating state.

6. A drainage element according to claim 5, wherein the randomly oriented interlacing and the filter mat are sewn together.

7. A drainage element according to claim 5, wherein the randomly oriented interlacing and the filter mat are glued together.

8. A drainage element according to claim 5, wherein the randomly oriented interlacing and the filter mat are welded together.
